(19) United States
(12) Patent Application Publication
(10) Pub. No.: US 2017/0159259 A1
(43) Pub. Date: Jun. 8, 2017

(54) DEVICE FOR RETAINING SOLIDS, METHODS FOR MANUFACTURING AND FOR SECURING SUCH A DEVICE, FILTRATION DEVICE AND METHODS FOR MANUFACTURING AND DEPLOYING SUCH A DEVICE

(71) Applicant: GÉCO INGÉNIERIE, LAUDUN L'ARDOISE (FR)

(72) Inventor: FRÉDÉRIC ROURE, LAUDUN L'ARDOISE (FR)

(21) Appl. No.: 15/317,408

(22) PCT Filed: Jun. 11, 2015
(86) PCT No.: PCT/EP2015/063105

§ 371 Date: Dec. 9, 2016

(30) Foreign Application Priority Data
Jun. 11, 2014 (FR) 1455310
Jun. 11, 2014 (FR) 1455311

(51) Int. Cl. E02D 17/20; B01D 39/16

(52) U.S. Cl. CPC E02D 17/202; B01D 39/1615; E02D 2200/14; E02D 2300/0051; E02D 2300/0085; E02D 2600/40; E02D 2220/00; E02D 2600/30; B01D 2239/0618; B01D 2239/0654

(57) ABSTRACT

A device for retaining solids includes a meshing, a removable fastener, and a covering. The meshing is made of synthetic material. The removable fastener to secure the covering is made of vegetable fiber to at least one portion of the meshing. The covering is made of vegetable fiber to cover at least part of the meshing.

### TECHNICAL FIELD OF THE INVENTION

The present invention envisages a device for retaining solids, a method for manufacturing such a device, a method for securing such a device, a device for filtering and draining a body of water or waterway, a method for manufacturing such a device, and a method for deploying such a device. It applies, in particular, to propping up road embankments and cliffs.

### STATE OF THE ART

In order to prop up an embankment or rocks and earth making a cliff, current systems utilize a steel grid lined with a plastic covering. This grid is fastened to the embankment or cliff to limit the likelihood of solids falling from this embankment or cliff.

The disadvantage of these systems is that their impact on the environment and landscape is unsatisfactory, given the synthetic nature of the means utilized.

In addition, current systems do not allow vegetation to grow on the surface where the system is placed.

### SUBJECT OF THE INVENTION

The present invention aims to remedy all or part of these drawbacks.

To this end, according to a first aspect, the present invention envisages a device for retaining solids, which comprises:
a meshing made of synthetic material;
a removable fastener for securing a covering made of vegetable fiber to at least one portion of the meshing; and
the covering made of vegetable fiber for covering at least part of the meshing.

Using a covering made of vegetable fiber makes it possible to improve the device's ability to grow vegetation, thus reducing the ecological footprint of the device, depending on environmental conditions. Vegetable fiber enables growing vegetation embryos such as seeds, for example.

In some embodiments, the covering made of vegetable fiber covers at least half the surface of the meshing.

The advantage of these embodiments is to enable greater vegetation growth on the device because of the proportion of meshing covered with vegetable fiber.

In some embodiments, the positioning of the covering is centered on the meshing.

The advantage of these embodiments is to enable regular vegetation growth where several similar devices, which are the subjects of the present invention, are used to cover a surface of an embankment or cliff, for example.

In some embodiments, the meshing is made of biodegradable geotextile.

The advantage of these embodiments is that they reduce the device's ecological footprint.

In some embodiments, the covering comprises hemp fibers.

The advantage of these embodiments is that they provide a low-cost installation and improved vegetation growth over the device.

In some embodiments, the covering is biodegradable.

The advantage of these embodiments is that they reduce the device's ecological footprint and improve the incorporation of the device in a landscape, especially for steep embankments.

In some embodiments, the meshing comprises a means for securing to a surface.

The advantage of these embodiments is that they allow the device to be kept in place on a surface.

In some embodiments, the covering is configured to hold seeds so as to grow vegetation over a surface on which the device has been deployed.

The advantage of these embodiments is to enable greater vegetation growth on the device because of the proportion of meshing covered with the vegetable fiber.

In some embodiments, the device that is the subject of the present invention comprises a means for unrolling the meshing over the surface.

The advantage of these embodiments is that they make it easier for a user to position the meshing over the surface.

In some embodiments, the device that is the subject of the present invention comprises eyelets configured to allow rods to pass through so as to secure the device to a surface supporting said device.

These embodiments make it possible to secure the device to a surface by means of fastening rods.

In some embodiments, the covering is made of non-woven fiber geotextile.

According to a second aspect, the present invention envisages a method for manufacturing the device for retaining solids that is the subject of the present invention, which comprises:
a step of attaching a covering made of vegetable fiber to a meshing made of synthetic material, and
a step of securing the covering to the meshing.

As the aims, advantages and features of the method that is the subject of the present invention are similar to those of the device that is the subject of the present invention, they are not repeated here.

In some embodiments, the method that is the subject of the present invention comprises a step of winding the meshing around a shaft.

The advantage of these embodiments is that they simplify positioning the device on a surface to be covered by unrolling the meshing.

According to a third aspect, the present invention envisages a method for securing the device for retaining solids that is the subject of the present invention, which comprises:
a step of deploying a meshing, covered with a covering made of vegetable fiber, over a solid surface such that the covering is at least partly in contact with the surface, and
a step of securing the meshing to the surface.

As the aims, advantages and features of the method that is the subject of the present invention are similar to those of the device that is the subject of the present invention, they are not repeated here.

In some embodiments, the deployment step comprises a step of unrolling the meshing.

The advantage of these embodiments is that they enable easier positioning by a user of the device over a surface to be covered.

According to a fourth aspect, the present invention envisages a device for filtering and draining a body of water or waterway, which comprises:
a net, made of synthetic material, that can be rolled up, configured to retain solids once rolled up, comprising a means for maintaining in the rolled-up position, and
a filter made of vegetable fiber, positioned on one side of the net, configured to be kept in the net when the net is rolled up.

Using a filter made of vegetable fiber allows the device to have a smaller ecological footprint than the current systems. In particular, rolling up the net makes it possible, once the draining or filtering is complete, to discard the vegetable fiber and reuse the net.

In some embodiments, the device that is the subject of the present invention comprises a means of pinching at least one end of the net when the net is rolled up.

These embodiments make it possible to hold the filter made of vegetable fiber in the rolled-up net.

In some embodiments, the device that is the subject of the present invention comprises a means of securing the rolled-up net to a solid surface, so that a portion of the net is at least partially immersed in the water.

The advantage of these embodiments is that they make it possible to hold the device in position once this device has been immersed in water.

In some embodiments, the filter comprises hemp fibers.

The advantage of these embodiments is that they reduce the device's ecological footprint.

In some embodiments, the net is made of biodegradable geotextile.

The advantage of these embodiments is that they further reduce the device's ecological footprint.

According to a fifth aspect, the present invention envisages a method for manufacturing a device for filtering and draining a body of water or waterway, which comprises:
a step of depositing a filter made of vegetable fiber over a net made of synthetic material;
a step of securing the filter to the net; and
a step of rolling up the net.

As the aims, advantages and features of the method that is the subject of the present invention are similar to those of the device that is the subject of the present invention, they are not repeated here.

In some embodiments, the method that is the subject of the present invention comprises a step of pinching at least one end of the net.

These embodiments enable the filter made of vegetable fiber to be held in the net when the net is rolled up and moved.

According to a sixth aspect, the present invention envisages a method for deploying a device for filtering and draining a body of water or waterway, which comprises:
a step of immersing the device into the material so as to cut off the flow of the material, and
a step of securing the positioning of the device.

Securing the positioning of the device enables the device to be kept in place during a filtering or draining of a body of water or waterway.

### BRIEF DESCRIPTION OF THE FIGURES

Other advantages, aims and particular features of the invention will become apparent from the non-limiting description that follows of at least one particular embodiment of the device and method that are the subjects of the present invention, with reference to drawings included in an appendix, wherein:

FIG. 1 represents, schematically, in a top view, a particular embodiment of the device that is the subject of the present invention;

FIG. 2 represents, schematically, a logical diagram of particular steps of the method that is the subject of the present invention;

FIG. 3 represents, schematically, a logical diagram of particular steps of the method that is the subject of the present invention;

FIG. 4 represents, schematically, in a top view, a particular embodiment of the device that is the subject of the present invention;

FIG. 5 represents, schematically and in cross-section, a particular embodiment of the device that is the subject of the present invention;

FIG. 6 represents, schematically, a logical diagram of particular steps of the method that is the subject of the present invention; and

FIG. 7 represents, schematically, a logical diagram of particular steps of the method that is the subject of the present invention.

### DESCRIPTION OF EXAMPLES OF REALIZATION OF THE INVENTION

The present description is given as a non-limiting example.

For the rest of the document, the term “geotextile” will refer to a fabric, generally made of synthetic material, configured to let water pass through.

Advantageously, the embodiments described below can be combined.

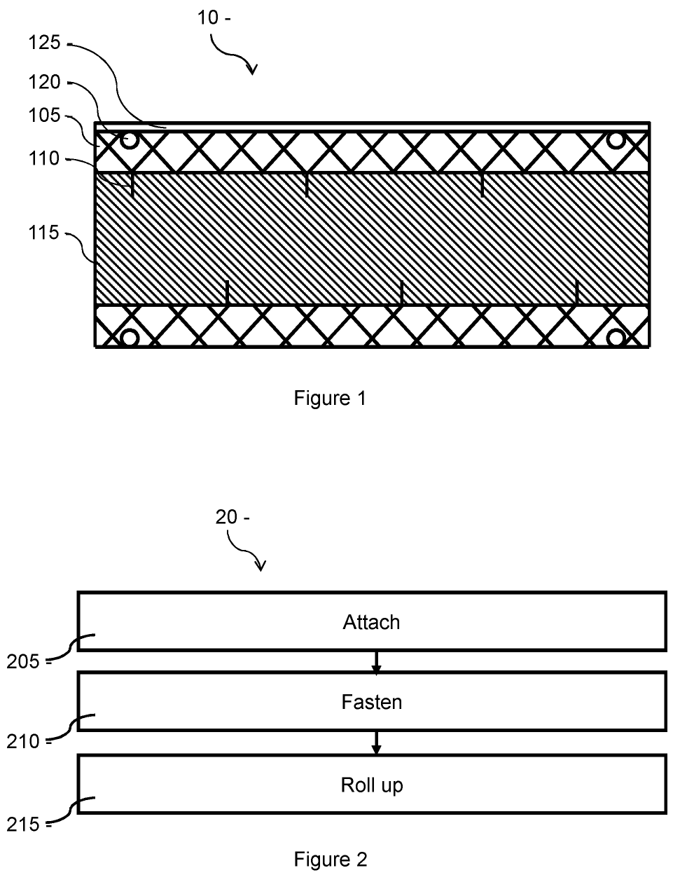

FIG. 1, which is not to scale, shows a cross-section view of an embodiment of the device 10 that is the subject of the present invention. This device 10 for retaining solids comprises:
a meshing 105, made of synthetic material, that comprises a means 120 for securing to a surface;
a removable means 110 of securing a covering 115 made of vegetable fiber to at least one portion of the meshing 105;
the covering 115 made of vegetable fiber for covering at least one portion of the meshing 105; and
a means 125 of unrolling the meshing 105 over the surface.

The meshing 105 is, for example, a geotextile latticework. The shape of this meshing 105 is, for example, generally rectangular and the perimeter of this meshing 105 is a thick geotextile frame. In some preferred variants, the meshing 105 is made of biodegradable natural fiber geotextile.

The removable means of securing 120 the meshing 105 to a surface is, for example, a set of eyelets positioned on at least one of the sides of the meshing 105. These eyelets are, for example, configured to receive the securing rods of the device 10. These rods are planted, for example, in the surface covered by the meshing 105, once the meshing 105 has been positioned by a user. In some variants, the securing means 120 is a latticework with reinforced edges acting as eyelets for securing rods.

The covering 115 made of vegetable fiber is, for example, a non-woven geotextile comprising:
crushed vegetation stems having a diameter of more than five millimeters,
vegetation stem fragments and
vegetable fibers partially attached to said crushed stems,
   the stems and stem fragments being interwoven by means of mechanical links produced by spraying water.

This covering 115 is produced, for example, by utilizing a method comprising:
a step of arranging vegetation into a mat of crushed vegetation with a diameter greater than five millimeters, vegetation stem fragments, and raw vegetable fibers partially attached to the crushed stems; and
a step of spraying water onto said mat so as to form mechanical links between the crushed vegetation stems, the vegetation stem fragments, and the vegetable fibers of said mat.

This method comprises, for example:
a step of introducing vegetation in the form of large-size vegetation, such as stems up to 2.5 meters in length, for example;
a step of partially reducing the vegetation into stems to form stem elements preferably over twenty centimeters long, and preferably over fifty centimeters long;
a step of crushing vegetation to form a mat of crushed vegetation with a diameter greater than five millimeters, vegetation stem fragments, and raw vegetable fibers partially attached to said crushed stems;
a step of pointing stems and/or fibers in different directions;
a step of making the thickness of the fiber mat uniform;
a step of incorporating ropes or cables into the fibers, parallel to the length of the fiber mat;
a step of creating mechanical links between the fibers of the mat, in the depth of the mat, by spraying water under pressure onto the vegetable fibers or, in a variant, with a multi-needle quilting machine.

The vegetation material used for implementing this method is, for example, a set of hemp fibers. Using vegetation material makes it possible, in particular, to make the covering 115 biodegradable.

This covering 115 covers the meshing 105 at least in part. Preferably, the covering 115 covers at least half the surface of the meshing 105. The covering 115 is positioned to form a strip with a shape similar to that of the meshing 105, centered on this meshing 105.

In some variants, the covering 115 covers at most 80% of the surface of the meshing 105. Preferably, the covering 115 covers at most half the surface of the meshing 105.

In this way, the covering 115 can form a strip joining two opposite sides of the meshing 105, this strip having a smaller surface area than the surface area of said side of the meshing 105.

The covering 115 is configured to hold seeds so as to grow vegetation over a surface on which the device 10 has been deployed. The seeds are held, for example, by the irregularities in the covering 115.

This covering 115 is configured to retain solids, particularly solids from the surface against which the device 10 is deployed, eg soil. In this way, these solids are retained on one side of the device 10.

The securing means 110 is, for example, a set of staples or rods that attach to the covering 115 so as to hold the covering 115 in place on the meshing 105.

The unrolling means 125 is, for example, a rigid structural element, such as a geotextile rod configured to allow the meshing 105 to be rolled up. In some variants, the unrolling means 125 is a shaft attached to a motor configured to drive this shaft in rotation, one side of the meshing 105 being fastened to the shaft such that, when the shaft is turning, the meshing 105 winds around the shaft. Once rolled up, the meshing 105 can be unhooked from the unrolling means 125.

The device 10 makes it possible, in particular, to grow vegetation on cliffs, walls, embankments and other sites that would otherwise be barren.

FIG. 2 shows a logical diagram of particular steps of the method 20 that is the subject of the present invention. This method 20 of manufacturing the device 10 for retaining solids comprises:
a step 205 of attaching a covering made of vegetable fiber to a meshing made of synthetic material;
a step 210 of securing the covering to the meshing; and
a step 215 of winding the meshing around a shaft.

The step 205 of attaching a covering made of vegetable fiber is performed, for example, by positioning the meshing over a flat surface and positioning the covering over this meshing. This positioning can be performed by a user or automatically.

The securing step 210 is performed, for example, by applying staples or adhesive to fasten the covering to the meshing.

The rolling-up step 215 is performed, for example, by fastening the meshing to a shaft linked to a motor configured to cause the shaft to rotate. When the shaft starts rotating, the meshing is rolled up around this shaft. In some variants, the shaft is then detached and is part of the device 10. In other variants, the meshing is detached from the shaft and moved for storing.

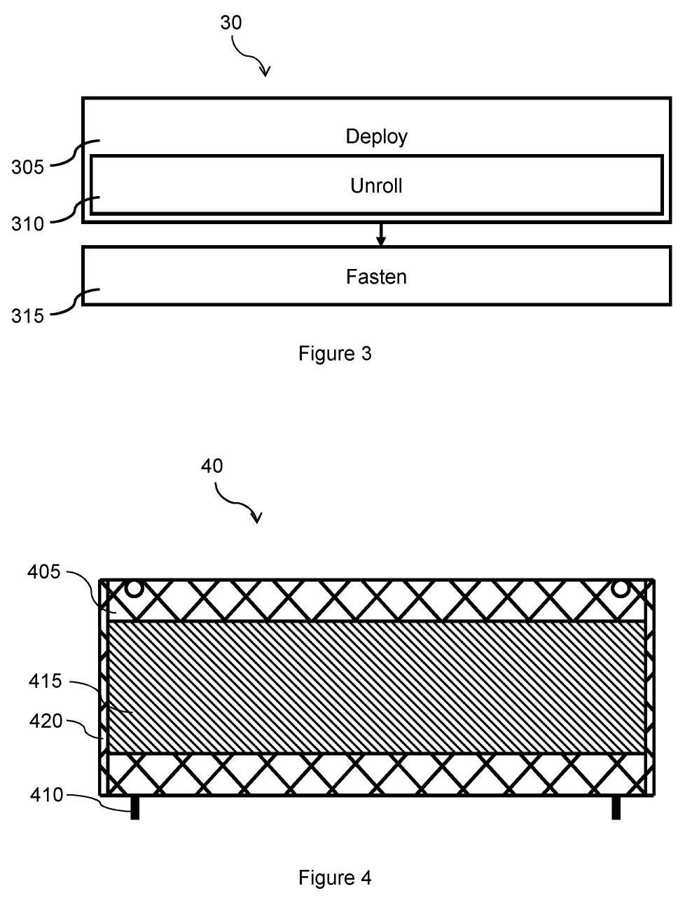

FIG. 3 shows a logical diagram of particular steps of the method 30 that is the subject of the present invention. This method 30 of securing the device 10 for retaining solids to a solid surface comprises:
a step 305 of deploying a meshing, covered with a covering made of vegetable fiber, over a solid surface such that the covering is at least partly in contact with the surface, which comprises a step 310 of unrolling the meshing; and
a step 315 of securing the meshing to the surface.

The deployment step 305 is performed, for example, by operating a means of unrolling the meshing. This unrolling means is, for example, a motor linked to a shaft around which the meshing is rolled up. When the shaft is driven in rotation by the motor, the meshing is unrolled. In some variants, the unrolling step 310 is performed by a user causing the rotation of the meshing so as to cause this meshing to unroll.

The step of securing 315 the meshing to the surface is performed, for example, by positioning rods in the eyelets of the meshing so as to attach the meshing to the surface. The covering of the device 10 is positioned against the surface and kept in position, firstly by this surface, and secondly by the meshing.

In some embodiments, the method 30 comprises a step of detaching the meshing from the covering.

In some embodiments, the method 30 comprises a step of removing the detached meshing from the covering.

FIG. 4 shows a particular embodiment of the device 40 that is the subject of the present invention. This device 40 for filtering and draining a body of water or waterway comprises:
a net 405, made of synthetic material, that can be rolled up, configured to retain solids once rolled up, comprising a means 410 of maintaining the rolled-up position, and
a filter 415 made of vegetable fiber, positioned on one side of the net 405, configured to be held in the net 405 when this net 405 is rolled up;
a means 420 of pinching at least one end of the net 405 when the net 405 is rolled up;
a means 410 of securing the rolled-up net 405 to a solid surface so that a portion of the net 405 is at least partially immersed in the water or placed on a rigid surface, such as the ground, for example.

The net 405 is, for example, a geotextile latticework. The shape of this meshing 405 is, for example, approximately rectangular and the perimeter of this meshing 405 is a thick geotextile frame. In some preferred variants, the meshing 405 is made of biodegradable natural fiber geotextile.

This net 405 is kept in in the rolled-up position by the means of maintaining 410 in the rolled-up position. This means of maintaining 410 is, for example, a set of hooks placed on one side of the net 405 parallel to the winding axis of the net 405, configured to attach themselves to the net 405 once it has been rolled up.

The vegetable fiber 415 is, for example, a biodegradable non-woven hemp fiber geotextile such as described in FIG. 1. In some variants, this filter 415 comprises several geotextile layers.

The pinching means 420 is, for example, a set of hooks placed on a longitudinal end of the net 405 when this net 405 is rolled up, these hooks making it possible to fold the rolled-up end of the net 405 over itself.

The securing means 410 is, for example, a set of eyelets positioned on the net 405 and configured to receive rigid rods enabling the net 405 to be secured onto a surface, such as the ground, for example.

In some variants, the net 405 is divided approximatively into two portions, one portion receiving a filter 415 and the other portion, folded above the filter 415, is secured to the first portion by means of staples or hooks for example.

The filter 415 is made of biodegradable geotextile, for example, this geotextile being in the form of a meshing wound about itself. This filter 415 is retained by the net 405, this net 405 being wound around the filter 415 and secured to securing means 410 for this net 405. In this way the net 405 is configured to be removed by putting the biodegradable material filter 415 down on a surface, such as the ground, for example. The filter 415 is not secured, for example, to the net 405 other than by the mechanical retention of the net 405 on the filter 415 while the net 405 is being rolled up. In some variants, the device 40 comprises a removable means of securing the filter 415 to the net 405.

In this way, the device 40 enables the retention of mud and solids present in a waterway when this device 40 is positioned across the waterway.

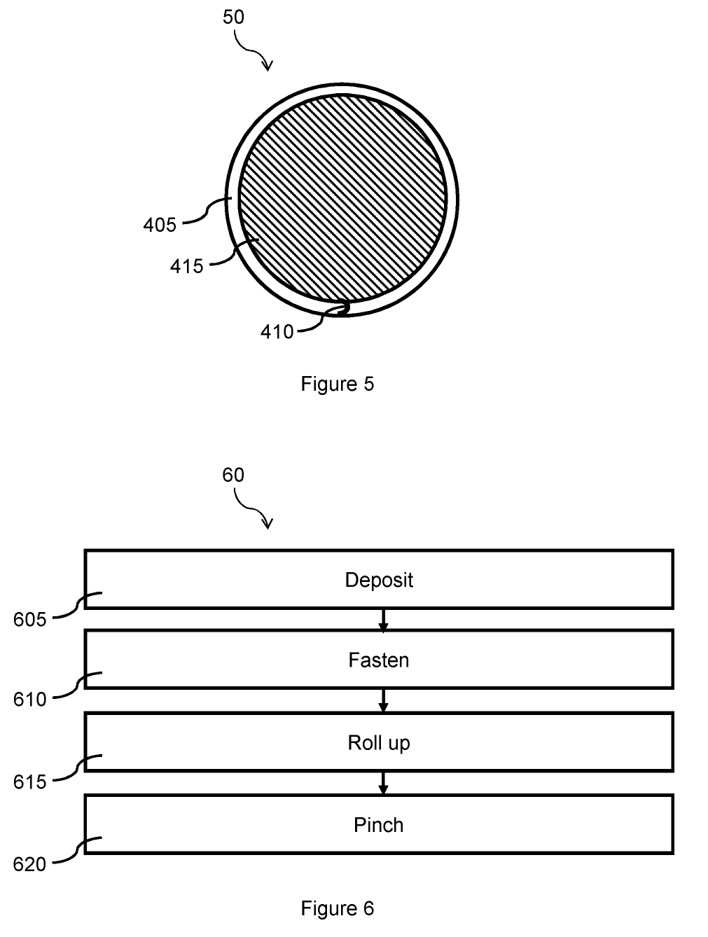

FIG. 5 shows a cross-section view of the device 50 as described in FIG. 4 when the net 405 is rolled up. In particular, it can be seen that when the net 405 is rolled up, the filter 415 is surrounded by the net 405.

FIG. 6 shows a logical diagram of particular steps of the method 60 that is the subject of the present invention. This method 60 for manufacturing a device 40 for filtering and draining a body of water or waterway comprises:
a step 605 of depositing a filter made of vegetable fiber over a net made of synthetic material;
a step 610 of securing the filter to the net;
a step 615 of rolling up the net; and
a step 620 of pinching at least one end of the net.

The depositing step 605 is performed, for example, by positioning the net on a flat surface and positioning the filter on the net. This positioning step can be performed by a user or automatically.

The step of securing 610 the filter to the net is performed, for example, by applying staples or adhesive so as to attach, at least partially, the filter and the net.

In some variants, the securing step 610 corresponds with a step of positioning the filter on the net, the filter and the net being secured to each other only by the winding of the net. In this way, when the net is being unrolled, the filter is released, to be placed on a surface above which the net is unrolled.

The rolling-up step 615 is performed, for example, by fastening the net to a shaft linked to a motor, this motor being configured to cause the shaft to rotate so as to roll up the filter during this rotation. In some variants, the rolling-up step 615 is performed by a user. This rolling-up step 615 comprises a step of securing the positioning of the net when the net is rolled up. This securing step is performed, for example, by using hooks present on one side of the net and configured to be hooked to the net once this net is rolled up.

The pinching step 620 is performed, for example, by utilizing hooks positioned over at least one longitudinal end of the net when the net is rolled up. These hooks make it possible to fold each said extremity over the rolled-up net so as to hold the filter in the net.

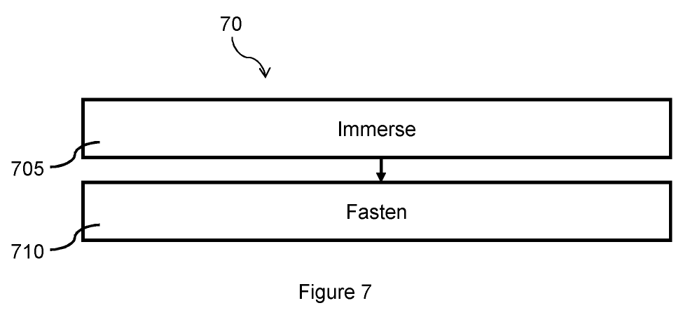

FIG. 7 shows a logical diagram of particular steps of the method 70 that is the subject of the present invention. This method 70 for deploying a device 40 for filtering and draining a body of water or waterway comprises:
a step 705 of immersing the device into the water so as to cut off the flow of the water, and
a step 710 of securing the positioning of the device.

The immersion step 705 is performed, for example, by a user positioning the device 40 across a waterway or in a body of water.

The securing step 710 is performed, for example, by inserting rigid rods into the net and into the ground below in order to keep the net in position. In some variants, the rods are inserted into eyelets in the net.

In this way, during the natural flowing of water along the waterway or body of water, the mud and solids moved by the water are held back by the device 40, enabling the waterway of body of water to be filtered.

In some embodiments, the method 70 comprises a step of unrolling the device so that the net is detached from the filter.

As is understood from reading this description, devices 10 and 40 utilize a biodegradable portion, in the form of the filter 415 or the covering 115, and a non-biodegradable portion, in the form of the net 405 and the meshing 105. The purpose of the non-biodegradable portion is to hold the biodegradable portion in place while this biodegradable portion is performing a function of filtration and vegetation growth, respectively. Once the function has been completed, the non-biodegradable portion is detached and reused, reducing the overall ecological impact of the device 10 or 40. The biodegradable portion can be left where the function was performed.

1-15. (canceled)

16. A device for retaining solids, comprising:
a meshing made of synthetic material;
a removable fastener to secure a covering made of vegetable fiber to at least one portion of the meshing; and
wherein the covering is made of vegetable fiber to cover at least part of the meshing.

17. The device according to claim 16, wherein the covering made of vegetable fiber covers at least half of a surface of the meshing.

18. The device according to claim 16, wherein a positioning of the covering is centered on the meshing.

19. The device according to claim 16, wherein the meshing is made of a biodegradable geotextile.

20. The device according to claim 16, wherein the covering comprises hemp fibers.

21. The device according to claim 16, wherein the covering is biodegradable.

22. The device according to claim 16, wherein the meshing comprises a fastener to secure to a surface.

23. The device according to claim 22, wherein the covering is configured to hold seeds to grow a vegetation over the surface on which the device is deployed.

24. The device according to claim 23, further comprising an unroller to unroll the meshing over the surface.

25. The device according to claim 16, further comprising eyelets configured to allow rods to pass through to secure the device to a surface supporting the device.

26. The device according to claim 16, wherein the covering is made of a non-woven fiber geotextile.

27. A method of manufacturing the device for retaining solids according to claim 16, comprising the steps of:
attaching the covering made of vegetable fiber to the meshing made of synthetic material; and
securing the covering to the meshing.

28. The method according to claim 27, further comprising a step of winding the meshing around a shaft.

29. A method of securing the device for retaining solids according to claim 16 to a solid surface, comprising the steps of:
deploying the meshing, covered with the covering made of vegetable fiber, over a solid surface such that the covering is at least partly in contact with the solid surface; and
securing the meshing to the solid surface.

30. The method according to claim 29, wherein the step of deploying comprises a step of unrolling the meshing.
